(19) United States
(12) Patent Application Publication
(10) Pub. No.: US 2026/0129710 A1
(43) Pub. Date: May 7, 2026

(54) SOURCE BASE STATION AND TRANSMISSION METHOD

(71) Applicant: INSTITUTE FOR INFORMATION INDUSTRY, TAIPEI (TW)

(72) Inventors: Hsien Tsung HSU, TAIPEI (TW); Yu An SHAO, TAIPEI (TW); Wen Yao CHANG, TAIPEI (TW)

(21) Appl. No.: 18/964,657

(22) Filed: Dec. 1, 2024

(30) Foreign Application Priority Data
Nov. 6, 2024 (TW) 113142582

(51) Int. Cl. H04W 76/20; H04W 36/36; H04W 64/00

(52) U.S. Cl. CPC H04W 76/20; H04W 36/362; H04W 64/006

(57) ABSTRACT

A source base station and transmission method are provided. A source base station transmits a radio resource control reconfiguration message to a user device. The radio resource control reconfiguration message includes an indication message and a candidate base station list, and the candidate base station list is used to indicate a plurality of candidate base stations. The source base station determines a non-target base station among the candidate base stations based on a prediction report received from the user device. The source base station transmits a handover cancel request to the non-target base station among the candidate base stations to make the non-target base station release a reserved resource corresponding to the user device.

### CROSS-REFERENCE TO RELATED APPLICATION

This application claims priority to Taiwan Application Serial Number 113142582, filed Nov. 6, 2024, which is herein incorporated by reference in its entirety.

### BACKGROUND

### Field of Invention

The present invention relates to a source base station and transmission method. More particularly, the present invention relates to a source base station and a transmission method that can improve the efficiency of mobile communication network resource usage.

### Description of Related Art

In the existing traditional handover (HO) operation, the operation still relies on the measurement report of the user device and the decision-making of the source base station (source gNB), and the handover is triggered when the signal strength reaches the threshold. However, this method needs to be very strict in setting the threshold. A slight error can easily lead to premature or late handover, and can easily lead to handover failure and service interruption.

In the prior art, conditional handover operation has been proposed. The source base station evaluates the measurement report of the user device, requests reserved resources from potential handover candidate base stations in advance, and notifies the user device of the handover conditions of each candidate base station. The conditional handover operation can effectively reduce the probability of handover failure and improve the handover smoothness of the user device.

However, according to the current handover specifications, the source base station will require multiple potential candidate base stations to reserve resources in advance to ensure continuous connection and service quality when the user device is moving. In this case, these reserved resources need to remain occupied before the user device actually switches. When the user device detects that a candidate base station meets the handover conditions, the user device will select one of the candidate base stations for handover operation. In other words, all potential candidate base stations will reserve resources and wait for the user device to perform the handover, and will only receive a resource release notification from the source base station after the user device successfully performs the handover.

Under the development trend of 5G/6G network densification, user devices will frequently perform handovers; and the current handover operation specifications for the release of candidate base station reserved resources will affect the overall system performance, such as: connection capacity.

Accordingly, there is an urgent need for a source base station and a transmission method that can improve the efficiency of mobile communication network resource usage.

### SUMMARY

An objective of the present disclosure is to provide a source base station. The source base station includes a transceiver interface and a processor. The transceiver interface is communicatively connected to a user device and a plurality of candidate base stations. The processor is electrically connected to the transceiver interface. The processor transmits a radio resource control reconfiguration message to the user device, wherein the radio resource control reconfiguration message comprises an indication message and a candidate base station list, and the candidate base station list is configured to indicate the candidate base stations. The processor determines a non-target base station among the candidate base stations based on a prediction report received from the user device, wherein the prediction report is generated based on the indication message. The processor transmits a handover cancel request to the non-target base station among the candidate base stations to make the non-target base station release a reserved resource corresponding to the user device.

Another objective of the present disclosure is to provide a transmission method, which is adapted for use in a source base station. The source base station is communicatively connected to a user device and a plurality of candidate base stations. The transmission method comprises the following steps: transmitting a radio resource control reconfiguration message to the user device, wherein the radio resource control reconfiguration message comprises an indication message and a candidate base station list, and the candidate base station list is configured to indicate the candidate base stations; determining a non-target base station among the candidate base stations based on a prediction report received from the user device, wherein the prediction report is generated based on the indication message; and transmitting a handover cancel request to the non-target base station among the candidate base stations to make the non-target base station release a reserved resource corresponding to the user device.

According to the above descriptions, the transmission technology (including the source base station and the method) provided by the present disclosure actively transmits the radio resource control reconfiguration message including the indication message and the candidate base station list to the user device by the source base station, causing the user device to generate a corresponding prediction report based on the indication message. Then, the source base station may determine a non-target base station among the candidate base stations based on a prediction report received from the user device. Accordingly, the source base station may transmit a handover cancel request to the non-target base station among the candidate base stations in advance to make the non-target base station release the reserved resources corresponding to the user device. Since the transmission technology provided by the present disclosure can notify non-target base stations of releasing reserved resources in advance, the resource usage efficiency of the mobile communication system can be improved.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting the architecture of a mobile communication system;

FIG. 2 is a schematic view depicting the architecture of a base station;

FIG. 3 is a schematic view depicting the architecture of a user device;

FIG. 4 is a partial process flow diagram depicting an embodiment of the present disclosure;

FIG. 5 is a partial process flow diagram depicting an embodiment of the present disclosure;

FIG. 6 is a sequence diagram depicting an embodiment of the present disclosure; and

FIG. 7 is a schematic flowchart depicting another embodiment of the present disclosure.

### DETAILED DESCRIPTION

In the following description, a source base station and transmission method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

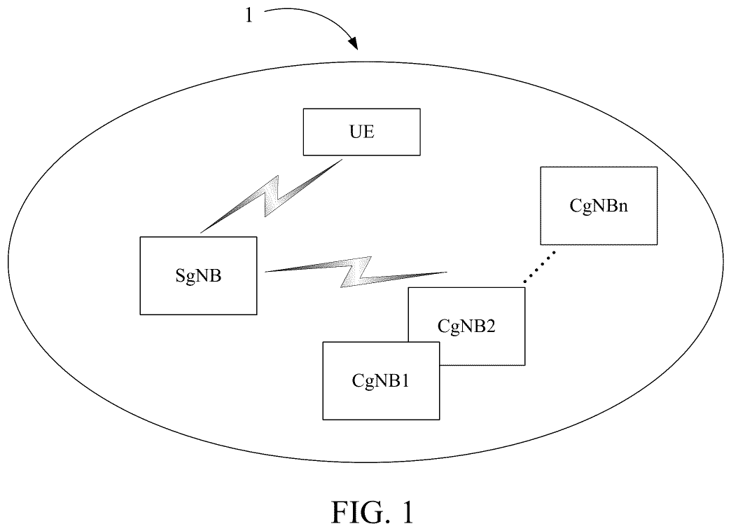

First, the applicable scene of an embodiment of the present disclosure will be described, and a schematic view is depicted in FIG. 1. As shown in FIG. 1, the mobile communication system 1 includes a user device UE, a source base station SgNB (source gNB, referred to as SgNB), and a plurality of candidate base stations CgNB1, CgNB2, . . . , CgNBn (candidate gNB, referred to as CgNB), where n is a positive integer.

In the present scenario, the source base station SgNB is communicatively connected with the user device UE, and the source base station SgNB is communicatively connected with the candidate base stations CgNB1, CgNB2, . . . , CgNBn.

It shall be appreciated that the source base station SgNB and the candidate base stations CgNB1, CgNB2, . . . , CgNBn are base stations that provide network services (for example: base stations in 5G or 6G networks). In the present disclosure, the source base station SgNB refers to the base station currently serving the user device UE. In addition, the candidate base stations CgNB1, CgNB2, . . . , CgNBn are base stations that are expected to become the target of handover operations for the user device UE (for example: base stations adjacent to the user device or base stations located on the trajectory of the user device).

In the present scenario, the source base station SgNB provides the candidate base stations CgNB1, CgNB2, . . . , CgNBn to the user device UE, so that the user device UE can perform handover operations after deciding on the target base station. It shall be appreciated that the present disclosure does not limit the number of candidate base stations in the mobile communication system 1 (i.e., the number of candidate base stations that are communicatively connected to the source base station SgNB).

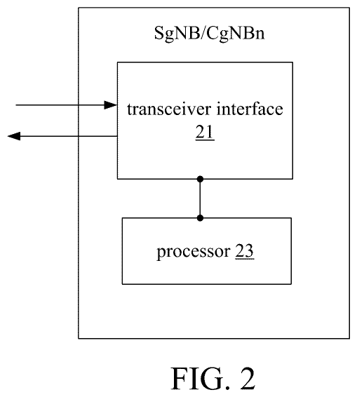

In the present embodiment, a schematic architectural diagram of a base station is depicted in FIG. 2 (taking the source base station SgNB and the candidate base station CgNBn as examples). The source base station SgNB and the candidate base station CgNBn at least include a transceiver interface 21 and a processor 23. The processor 23 is electrically connected to the transceiver interface 21.

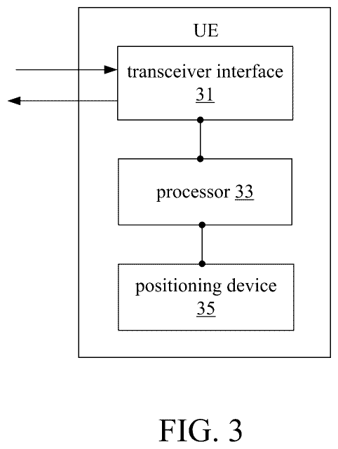

In addition, in the present embodiment, the architectural schematic diagram of the user device UE is depicted in FIG. 3. The user device UE includes a transceiver interface 31, a processor 33, and a positioning device 35. The processor 33 is electrically connected to the transceiver interface 31 and the positioning device 35.

It shall be appreciated that the aforementioned FIG. 2 and FIG. 3 only illustrate elements of the source base station SgNB, the candidate base station CgNBn, and the user device UE related to the operations of the present disclosure. It shall be appreciated that during actual operations, the base station SgNB, the candidate base station CgNBn, and the user device UE may still include other components necessary for operations (such as communication-related devices, storage, inertial sensors, display screens, and other transceiver interfaces).

It shall be appreciated that each of the transceiver interface 21 and the transceiver interface 31 is an interface capable of receiving and transmitting data or other interfaces capable of receiving and transmitting data and known to those of ordinary skill in the art. The transceiver interface 21 and the transceiver interface 31 can receive data from sources such as external apparatuses, external web pages, external applications, and so on. Each of the processor 23 and the processor 33 may be any of various processors, Central Processing Units (CPUs), microprocessors, digital signal processors or other computing apparatuses known to those of ordinary skill in the art. The positioning device 35 can be any device with a positioning function, such as a Global Positioning System (GPS), a WiFi positioning device, etc.

The purpose of the present disclosure will be briefly described first. The purpose of the present disclosure is for the source base station SgNB to determine non-target base stations with a low probability of handover based on the status reported by the user device UE (such as trajectory, connection quality, etc.). Accordingly, the source base station SgNB can send notification of resource release to the candidate base station in advance, allowing the candidate base station with a low probability of handover to release the reserved resources in advance, and without waiting for the user device to perform handover successfully before releasing resources. Therefore, it can improve the efficiency of resource utilization in mobile communication systems.

For ease of understanding, the operation stages of the first embodiment of the present disclosure will be described first. Specifically, the operations of the present disclosure can be divided into five stages, which are (1) triggering prediction on the user device UE, (2) prediction on the user device UE, (3) reporting prediction result on the user device UE, (4) operations on the source base station SgNB, and (5) execution of conditional handover. The following paragraphs will detail the operation of each stage.

The following will describe the specific operations of (1) triggering prediction on the user device UE. First, in the present embodiment, the processor 23 of the source base station SgNB may notify the user device UE of activating the prediction operation by carrying the indication message in an RRCR (Radio Resource Control Reconfiguration) message.

Specifically, the processor 23 transmits a radio resource control reconfiguration message to the user device UE, wherein the radio resource control reconfiguration message includes an indication message and a candidate base station list, and the candidate base station list is configured to indicate the candidate base stations (e.g., the candidate base stations CgNB1, CgNB2, . . . , CgNBn).

In some embodiments, the indication message includes a decision indication, a prediction parameter indication, and an output type indication. For example, the decision indication is configured to indicate whether the user device UE participates in the decision-making or the source base station SgNB makes the decision on its own.

In addition, the prediction parameter indication is configured to indicate the prediction parameters that need to be included. For example, the predicted parameter may include one of the measured time, the measured time interval, the measured quantity, the predicted time, the predicted time interval, or a combination thereof.

In addition, the output type indication may be configured to indicate the output format of prediction and decision-making. For example, the output type indication may include one of the predicted quantity, the outcome type of the decision (e.g., probability or yes/no), or a combination thereof.

It shall be appreciated that the indication message can be designed as an IE (information element) so as to be carried in the control message, such as the RRC Reconfiguration message.

In some embodiments, the candidate base stations in the candidate base station list are generated by the source base station SgNB performing a conditional handover decision operation.

In some embodiments, the processor 23 receives a handover request confirmation message from each of the candidate base stations. Then, the processor 23 generates the radio resource control reconfiguration message based on the handover request confirmation messages.

The following will describe the specific operations of (2) prediction on the user device UE.

In the present embodiment, the user device UE generates a prediction report based on the indication message included in the radio resource control reconfiguration message. For example, the user device UE collects the required observation data according to the prediction parameter indication in the indication message. The user device UE can generate prediction reports through AI/ML, such as LSTM model and RNN model. For another example, the user device UE can predict signal changes in a short time in the future based on the output type indication (for example: RSRP, RSRQ, etc.), and adjust the output format of the prediction.

Furthermore, the user device UE determines whether to participate in the decision-making according to the decision indication in the indication message. If further decision-making is required, the user device UE can analyze the signal predicted in the previous step through AI/ML (for example: RL model, DRL model), and output the handover probability of each candidate base station (probability, yes/no, etc.) in a short time according to the output type indications.

Specifically, the user device UE can collect historical measurement signal information (such as RSRP, RSRQ, speed, direction, time, location characteristics of the user device UE) as a training data set to train a prediction model. For example, the trained prediction model can predict the RSRP or RSRQ value of the user device UE at a certain time point/time interval in the future.

In addition, the user device UE may train the determination model by collecting historical measurement signal information and determination results (for example, handover results of the user device UE for each candidate base station) as a training data set.

For example, the user device UE can input the historical RSRP/RSRQ values of each candidate base station and the source base station as input to the determination model. In addition, the user device UE can also input the current signal status (such as the speed, position, and handover history of the user device UE) into the determination model as an auxiliary feature. Accordingly, the trained determination model can determine the handover probability corresponding to each candidate base station.

In some embodiments, the prediction report may further include trajectory information of the user device UE. The user device UE and the source base station SgNB can further use the trajectory information to determine non-target base stations with lower handover probabilities in the future (for example: the closer the trajectory is to a candidate base station, the higher the handover probability; on the contrary, the farther the trajectory is from the candidate base station, the lower the handover probability).

Specifically, the user device UE measures a trajectory information of the user device UE. Then, the user device UE generates the prediction report based on a historical signal sequence value of each of the candidate base stations and the trajectory information of the user device UE.

In some embodiments, the trajectory information includes a spatial position, a moving direction, and a moving speed of the user device UE.

The following will describe the specific operations of (3) reporting prediction result on the user device UE and (4) operations on the source base station SgNB.

In the present embodiment, the processor 23 determines the non-target base station among the candidate base stations based on the prediction report received from the user device UE, and the prediction report is generated based on the indication message.

It shall be appreciated that the non-target base station of the present disclosure can be decided by the user device UE participating in decision-making or by the source base station SgNB making the decision on its own. In addition, in some embodiments, the source base station SgNB can determine multiple non-target base stations at one time and perform corresponding resource release operations.

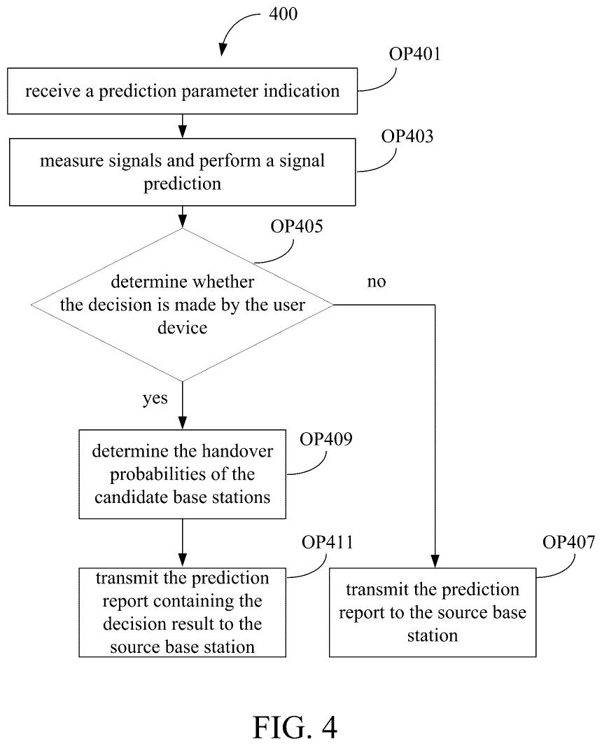

The following will first describe an embodiment in which the user device UE participates in decision-making. For ease of understanding, please refer to the partial flow diagram 400 in FIG. 4. In the present example, the user device UE performs the operation OP401 to receive a prediction parameter indication. Then, the user device UE executes the operation OP403 to measure signals and perform a signal prediction. Next, the user device UE executes the operation OP405 to determine whether the decision is made by the user device UE. If the result is no, the user device UE executes the operation OP407 to transmit the prediction report to the source base station SgNB. If the result is yes, the user device UE executes the operation OP409 to determine the handover probabilities of the candidate base stations. Then, the user device UE executes the operation OP411 to transmit the prediction report containing the decision result to the source base station SgNB.

In some embodiments, the indication message includes a decision indication. The processor 23 determines whether the indication message corresponds to a user device decision indication. Then, in response to the indication message corresponding to the user device decision indication, the processor 23 determines the non-target base station among the candidate base stations based on a first predicted base station indicated in the prediction report (i.e., the non-target base station predicted by the user device UE).

In some embodiments, the prediction reports generated by the user device UE may simultaneously indicate multiple non-target base stations.

In some embodiments, the source base station SgNB may check the predicted results of the user device UE to determine whether to use the first predicted base station as a non-target base station. Specifically, the prediction report includes a predicted signal change corresponding to each of the candidate base stations and the first predicted base station. In response to the indication message corresponding to the user device decision indication, the processor 23 generates a prediction confidence value corresponding to the first prediction base station based on the prediction signal change of each of the candidate base stations. Then, in response to the prediction confidence value being less than a threshold, the processor 23 determines the first predicted base station to be the non-target base station.

In some embodiments, the source base station SgNB can determine whether to set the first predicted base station as a non-target base station based on the status of the candidate base station (for example, load status, location and other information). Specifically, the prediction report includes a predicted signal change corresponding to each of the candidate base stations and the first predicted base station. The processor 23 receives a base station status information from each of the candidate base stations. Then, the processor 23 generates a prediction confidence value corresponding to the first prediction base station based on the prediction signal change corresponding to each of the candidate base stations and the base station status information of each of the candidate base stations. Finally, in response to the prediction confidence value being less than a threshold, the processor 23 determines the first predicted base station to be the non-target base station.

In some embodiments, the base station status information includes a load status and a current location.

The following will first describe the embodiment of decision-making by the source base station SgNB.

In some embodiments, the source base station SgNB can directly determine the non-target base station based on the prediction report returned by the user device UE. Specifically, the prediction report includes a predicted signal change corresponding to each of the candidate base stations. The processor 23 selects a second predicted base station (i.e., a non-target base station predicted by the source base station SgNB) from the candidate base stations based on the predicted signal change corresponding to each of the candidate base stations. Next, the processor 23 sets the second predicted base station as the non-target base station.

In some embodiments, the source base station SgNB may determine whether to set the second prediction base station as a non-target base station based on the status of the candidate base station (for example, information of load status, location, etc.). Specifically, the processor 23 receives a base station status information from each of the candidate base stations. Next, the processor 23 selects the second predicted base station from the candidate base stations based on the predicted signal change corresponding to each of the candidate base stations and the base station status information of each of the candidate base stations. Finally, the processor 23 sets the second predicted base station as the non-target base station.

It shall be appreciated that the prediction report can be designed as an IE (information element) so as to be carried in the control message, for example, measurement report message.

Finally, in the present embodiment, after determining the non-target base station, the source base station SgNB can notify the candidate base stations belonging to the non-target base station of releasing the reserved resources. Specifically, the processor 23 transmits a handover cancel request to the non-target base station among the candidate base stations to make the non-target base station release a reserved resource corresponding to the user device UE.

It shall be appreciated that after the processor 23 transmits the handover cancel request to the non-target base station among the candidate base stations, the source base station SgNB, the user device UE and other candidate base stations can continue to perform the aforementioned (5) execution of conditional handover.

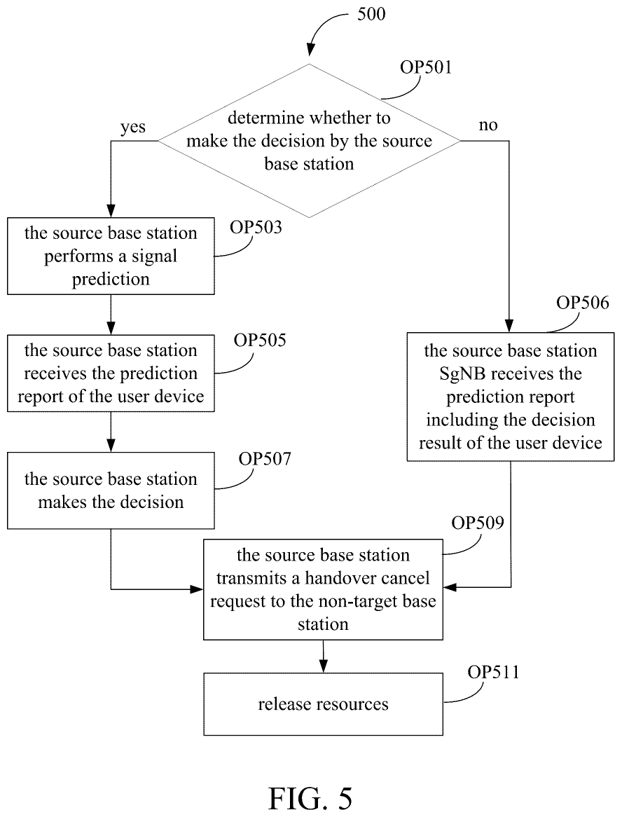

For ease of understanding, please refer to the partial flow diagram 500 in FIG. 5. In the present example, the processor 23 executes the operation OP501 to determine whether to make the decision by the source base station SgNB. If the result is yes, the processor 23 executes the operation OP503, and the source base station SgNB performs a signal prediction. Next, the processor 23 executes the operation OP505, and the source base station SgNB receives the prediction report of the user device UE. Then, the processor 23 executes the operation OP507, and the source base station SgNB makes the decision. Next, the processor 23 executes the operation OP509, and the source base station SgNB transmits a handover cancel request to the non-target base station. Then, the candidate base stations perform the operation OP511 to release resources.

Based on the above, if the result is no, the processor 23 executes the operation OP506, and the source base station SgNB receives the prediction report including the decision result of the user device UE (i.e., the first predicted base station is indicated in the prediction report). Next, the processor 23 executes the operation OP509, and the source base station SgNB transmits a handover cancel request to the non-target base station. Then, the candidate base stations execute the operation OP511 to release resources.

In some embodiments, the processor 23 receives a handover success message from a target base station. Then, in response to receiving the handover success message from the target base station, the processor 23 transmits a state transfer message to the target base station, wherein the state transfer message includes a sequence number.

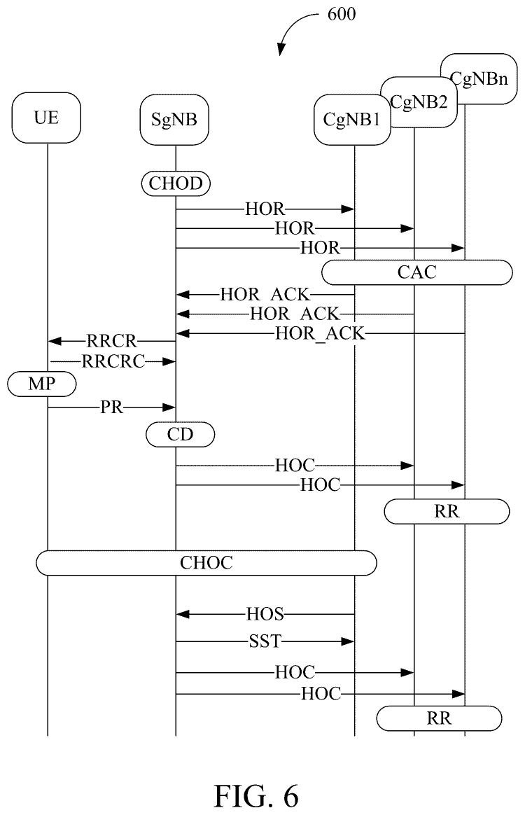

For ease of understanding, please refer to the sequence diagram 600 in FIG. 6. In the present example, the source base station SgNB executes the conditional handover decision CHOD (CHO Decision), and transmits the handover request HOR to the candidate base stations CgNB1, CgNB2, . . . , CgNBn. Then, the candidate base stations CgNB1, CgNB2, . . . , CgNBn perform a call admission control (CAC), and return the handover request response HOR_ACK to the source base station SgNB.

Next, the source base station SgNB transmits the radio resource control reconfiguration message RRCR to the user device UE, and the source base station SgNB receives the radio resource control reconfiguration completion message RRCRC from the user device UE.

Next, the user device UE performs measurement and prediction (MP), and transmits a prediction report (PR) to the source base station SgNB. Then, the source base station SgNB executes the cancel decision (CD) and transmits the handover cancel request (HOC) to the non-target base stations CgNB2 and CgNBn. Next, the non-target base stations CgNB2 and CgNBn perform resource release (RR).

In addition, in the present example, the user device UE, the source base station SgNB and the target base station CgNB1 perform conditional handover completion (CHOC). Then, the target base station CgNB1 transmits a handover success (HOS) to the source base station SgNB. The source base station SgNB transmits the sequence number (SN) status transfer (SST) to the target base station CgNB1. Finally, the source base station SgNB transmits a transmission handover cancel request (HOC) to the non-target base stations CgNB2 and CgNBn. The non-target base stations CgNB2 and CgNBn perform traditional resource release (RR).

According to the above descriptions, the mobile communication system 1 provided by the present disclosure actively transmits the radio resource control reconfiguration message including the indication message and the candidate base station list to the user device UE by the source base station SgNB, causing the user device UE to generate a corresponding prediction report based on the indication message. Then, the source base station SgNB may determine a non-target base station among the candidate base stations based on a prediction report received from the user device UE. Accordingly, the source base station SgNB may transmit a handover cancel request to the non-target base station among the candidate base stations in advance to make the non-target base station release the reserved resources corresponding to the user device UE. Since the source base station SgNB provided by the present disclosure can notify non-target base stations of releasing reserved resources in advance, the resource usage efficiency of the mobile communication system 1 can be improved.

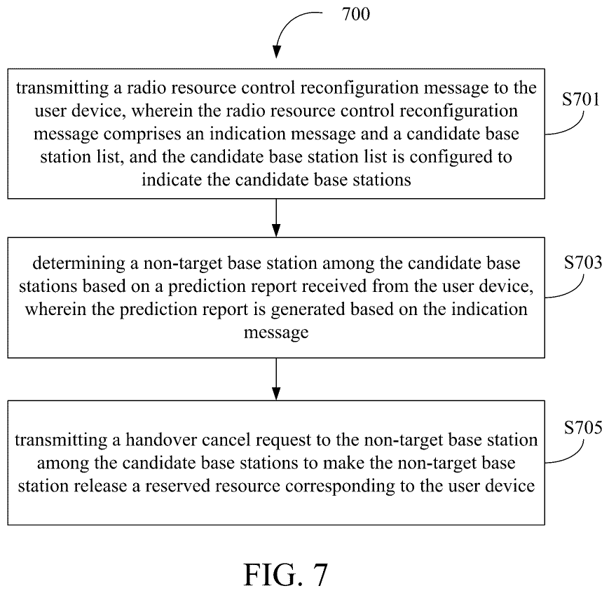

Another embodiment of the present disclosure is a transmission method, and a flowchart thereof is depicted in FIG. 7. The transmission method 700 is applicable to the source base station, such as the source base station SgNB described in the first embodiment. The source base station is communicatively connected to the user device and a plurality of candidate base stations, such as the user device UE and the candidate base stations CgNB1, CgNB2, . . . , CgNBn described in the first embodiment. The transmission method 700 transmits the handover cancel request through the steps S701 to S705.

In the step S701, the source base station transmits a radio resource control reconfiguration message to the user device, wherein the radio resource control reconfiguration message includes an indication message and a candidate base station list, and the candidate base station list is configured to indicate the candidate base stations. Next, in the step S703, the source base station determines a non-target base station among the candidate base stations based on a prediction report received from the user device, wherein the prediction report is generated based on the indication message.

Finally, in the step S705, the source base station transmits a handover cancel request to the non-target base station among the candidate base stations to make the non-target base station release a reserved resource corresponding to the user device.

In some embodiments, the indication message includes a decision indication, and the step of determining the non-target base station further includes the following steps: determining whether the indication message corresponds to a user device decision indication; and in response to the indication message corresponding to the user device decision indication, determining the non-target base station among the candidate base stations based on a first predicted base station indicated in the prediction report.

In some embodiments, the prediction report includes a predicted signal change corresponding to each of the candidate base stations and the first predicted base station, and the step of determining the non-target base station further includes the following steps: in response to the indication message corresponding to the user device decision indication, generating a prediction confidence value corresponding to the first prediction base station based on the prediction signal change of each of the candidate base stations; and in response to the prediction confidence value being less than a threshold, determining the first predicted base station to be the non-target base station.

In some embodiments, the prediction report includes a predicted signal change corresponding to each of the candidate base stations and the first predicted base station, and the step of determining the non-target base station further includes the following steps: receiving a base station status information from each of the candidate base stations; generating a prediction confidence value corresponding to the first prediction base station based on the prediction signal change corresponding to each of the candidate base stations and the base station status information of each of the candidate base stations; and in response to the prediction confidence value being less than a threshold, determining the first predicted base station to be the non-target base station.

In some embodiments, the prediction report includes a predicted signal change corresponding to each of the candidate base stations, and the step of determining the non-target base station further includes the following steps: selecting a second predicted base station from the candidate base stations based on the predicted signal change corresponding to each of the candidate base stations; and setting the second predicted base station as the non-target base station.

In some embodiments, the transmission method 700 further includes the following operations: receiving a base station status information from each of the candidate base stations; selecting the second predicted base station from the candidate base stations based on the predicted signal change corresponding to each of the candidate base stations and the base station status information of each of the candidate base stations; and setting the second predicted base station as the non-target base station.

In some embodiments, the base station status information includes a load status and a current location.

In some embodiments, the prediction report is generated by the user device performing the following steps: measuring a trajectory information of the user device; and generating the prediction report based on a historical signal sequence value of each of the candidate base stations and the trajectory information of the user device.

In some embodiments, the trajectory information includes a spatial position, a moving direction, and a moving speed of the user device.

In some embodiments, the transmission method 700 further includes the following steps: receiving a handover success message from a target base station; and in response to receiving the handover success message from the target base station, transmitting a state transfer message to the target base station, wherein the state transfer message includes a sequence number.

In some embodiments, the candidate base stations in the candidate base station list are generated by the source base station performing a conditional handover decision operation, and the transmission method 700 further includes the following steps: receiving a handover request confirmation message from each of the candidate base stations; and generating the radio resource control reconfiguration message based on the handover request confirmation messages.

In some embodiments, the indication message includes a decision indication, a prediction parameter indication, and an output type indication.

In addition to the aforesaid steps, the second embodiment can also execute all the operations and steps of the mobile communication system 1, the source base station SgNB, and the user device UE set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present disclosure, some words (e.g., the predicted base station) are preceded by terms such as “first” and “second”, and these terms of “first” and “second” are only used to distinguish these different words. For example, the “first” and “second” predicted base station are only used to indicate the predicted base station used in different operations.

According to the above descriptions, the transmission technology (including the source base station and the method) provided by the present disclosure actively transmits the radio resource control reconfiguration message including the indication message and the candidate base station list to the user device by the source base station, causing the user device to generate a corresponding prediction report based on the indication message. Then, the source base station may determine a non-target base station among the candidate base stations based on a prediction report received from the user device. Accordingly, the source base station may transmit a handover cancel request to the non-target base station among the candidate base stations in advance to make the non-target base station release the reserved resources corresponding to the user device. Since the transmission technology provided by the present disclosure can notify non-target base stations of releasing reserved resources in advance, the resource usage efficiency of the mobile communication system can be improved.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A source base station, comprising:
a transceiver interface, being communicatively connected to a user device and a plurality of candidate base stations; and
a processor, being electrically connected to the transceiver interface, and being configured to execute the following operations:
transmitting a radio resource control reconfiguration message to the user device, wherein the radio resource control reconfiguration message comprises an indication message and a candidate base station list, and the candidate base station list is configured to indicate the candidate base stations;
determining a non-target base station among the candidate base stations based on a prediction report received from the user device, wherein the prediction report is generated based on the indication message; and
transmitting a handover cancel request to the non-target base station among the candidate base stations to make the non-target base station release a reserved resource corresponding to the user device.

2. The source base station of claim 1, wherein the indication message comprises a decision indication, and the operation of determining the non-target base station further comprises the following operations:
determining whether the indication message corresponds to a user device decision indication; and
in response to the indication message corresponding to the user device decision indication, determining the non-target base station among the candidate base stations based on a first predicted base station indicated in the prediction report.

3. The source base station of claim 2, wherein the prediction report comprises a predicted signal change corresponding to each of the candidate base stations and the first predicted base station, and the operation of determining the non-target base station further comprises the following operations:
in response to the indication message corresponding to the user device decision indication, generating a prediction confidence value corresponding to the first prediction base station based on the prediction signal change of each of the candidate base stations; and
in response to the prediction confidence value being less than a threshold, determining the first predicted base station to be the non-target base station.

4. The source base station of claim 2, wherein the prediction report comprises a predicted signal change corresponding to each of the candidate base stations and the first predicted base station, and the operation of determining the non-target base station further comprises the following operations:
receiving a base station status information from each of the candidate base stations;
generating a prediction confidence value corresponding to the first prediction base station based on the prediction signal change corresponding to each of the candidate base stations and the base station status information of each of the candidate base stations; and
in response to the prediction confidence value being less than a threshold, determining the first predicted base station to be the non-target base station.

5. The source base station of claim 1, wherein the prediction report comprises a predicted signal change corresponding to each of the candidate base stations, and the operation of determining the non-target base station further comprises the following operations:
selecting a second predicted base station from the candidate base stations based on the predicted signal change corresponding to each of the candidate base stations; and
setting the second predicted base station as the non-target base station.

6. The source base station of claim 5, wherein the processor further executes the following operations:
receiving a base station status information from each of the candidate base stations;
selecting the second predicted base station from the candidate base stations based on the predicted signal change corresponding to each of the candidate base stations and the base station status information of each of the candidate base stations; and
setting the second predicted base station as the non-target base station.

7. The source base station of claim 6, wherein the base station status information comprises a load status and a current location.

8. The source base station of claim 1, wherein the prediction report is generated by the user device performing the following operations:
measuring a trajectory information of the user device; and
generating the prediction report based on a historical signal sequence value of each of the candidate base stations and the trajectory information of the user device.

9. The source base station of claim 8, wherein the trajectory information comprises a spatial position, a moving direction, and a moving speed of the user device.

10. The source base station of claim 1, wherein the processor further performs the following operations:
receiving a handover success message from a target base station; and
in response to receiving the handover success message from the target base station, transmitting a state transfer message to the target base station, wherein the state transfer message comprises a sequence number.

11. The source base station of claim 1, wherein the candidate base stations in the candidate base station list are generated by the source base station performing a conditional handover decision operation, and the processor further performs the following operations:
receiving a handover request confirmation message from each of the candidate base stations; and
generating the radio resource control reconfiguration message based on the handover request confirmation messages.

12. The source base station of claim 1, wherein the indication message comprises a decision indication, a prediction parameter indication, and an output type indication.

13. A transmission method, being adapted for use in a source base station, wherein the source base station is communicatively connected to a user device and a plurality of candidate base stations, and the transmission method comprises the following steps:
transmitting a radio resource control reconfiguration message to the user device, wherein the radio resource control reconfiguration message comprises an indication message and a candidate base station list, and the candidate base station list is configured to indicate the candidate base stations;
determining a non-target base station among the candidate base stations based on a prediction report received from the user device, wherein the prediction report is generated based on the indication message; and
transmitting a handover cancel request to the non-target base station among the candidate base stations to make the non-target base station release a reserved resource corresponding to the user device.

14. The transmission method of claim 13, wherein the indication message comprises a decision indication, and the step of determining the non-target base station further comprises the following steps:
determining whether the indication message corresponds to a user device decision indication; and
in response to the indication message corresponding to the user device decision indication, determining the non-target base station among the candidate base stations based on a first predicted base station indicated in the prediction report.

15. The transmission method of claim 14, wherein the prediction report comprises a predicted signal change corresponding to each of the candidate base stations and the first predicted base station, and the step of determining the non-target base station further comprises the following steps:
in response to the indication message corresponding to the user device decision indication, generating a prediction confidence value corresponding to the first prediction base station based on the prediction signal change of each of the candidate base stations; and
in response to the prediction confidence value being less than a threshold, determining the first predicted base station to be the non-target base station.

16. The transmission method of claim 14, wherein the prediction report comprises a predicted signal change corresponding to each of the candidate base stations and the first predicted base station, and the step of determining the non-target base station further comprises the following steps:
receiving a base station status information from each of the candidate base stations;
generating a prediction confidence value corresponding to the first prediction base station based on the prediction signal change corresponding to each of the candidate base stations and the base station status information of each of the candidate base stations; and
in response to the prediction confidence value being less than a threshold, determining the first predicted base station to be the non-target base station.

17. The transmission method of claim 13, wherein the prediction report comprises a predicted signal change corresponding to each of the candidate base stations, and the step of determining the non-target base station further comprises the following steps:
selecting a second predicted base station from the candidate base stations based on the predicted signal change corresponding to each of the candidate base stations; and
setting the second predicted base station as the non-target base station.

18. The transmission method of claim 17, wherein the transmission method further comprises the following operations:
receiving a base station status information from each of the candidate base stations;
selecting the second predicted base station from the candidate base stations based on the predicted signal change corresponding to each of the candidate base stations and the base station status information of each of the candidate base stations; and
setting the second predicted base station as the non-target base station.

19. The transmission method of claim 13, wherein the prediction report is generated by the user device performing the following steps:
measuring a trajectory information of the user device; and
generating the prediction report based on a historical signal sequence value of each of the candidate base stations and the trajectory information of the user device.

20. The transmission method of claim 19, wherein the trajectory information comprises a spatial position, a moving direction, and a moving speed of the user device.
